(19) United States
(12) Patent Application Publication
(10) Pub. No.: US 2011/0254465 A1
(43) Pub. Date: Oct. 20, 2011

(54) LIGHT EMITTING DIODE DRIVE CIRCUIT DEVICE

(76) Inventor: Wen-Shen CHEN, Yonghe City (TW)

(21) Appl. No.: 12/762,464

(22) Filed: Apr. 19, 2010

(51) Int. Cl. H05B 37/02

(52) U.S. Cl. 315/294

(57) ABSTRACT

The present invention discloses an LED drive circuit device. The LEDs are installed in a lamp-set and two ends of the lamp-set are provided respectively with two pins to receive a high frequency AC outputted from a ballast, with the two pins being further electrically connected with a drive circuit module. The drive circuit module includes primarily a resonant network correction circuit and a rectifying circuit. The resonant network correction circuit adjusts the high frequency AC received by the two pins to comply with an application range of LED current and then the rectifying circuit converts the AC into a DC which is next outputted through other two pins. By applying the aforementioned circuits, the LED lamp-set can be applied to an ordinary electronic ballast, thereby achieving high compatibility.

### BACKGROUND OF THE INVENTION

a) Field of the Invention

The present invention relates to an LED (Light Emitting Diode) lamp-set and more particularly to an LED drive circuit device which can be applied to any ballast and is highly compatible.

b) Description of the Prior Art

Energy saving has already been a goal to be advocated by every country for many years, as energy saving can achieve objects of protecting environment and not wasting resources. Electric energy is one of the energy sources which are consumed the most; staples, lighting equipment and household appliances should all be driven to operate through the electric energy. Particularly, companies should turn on the lighting equipment day and night to allow staffs to work efficiently; whereas, the lighting equipment used by a general company utilizes a ballast to ignite a lamp tube for illumination, wherein a conventional mercury lamp tube uses a conventional ballast to ignite, thereby achieving the illumination effect. However, for this ignition method and the fitted lamp tube, scintillation of optical wave propagation will be produced when igniting. As an ignition frequency of a conventional ballast is 60 Hz, meaning that there are 120 times of strobo flashes in one second, naked eyes can be easily aware of the flashing. Besides, the conventional ballast requires more electric energy, hence consumes more electricity relatively. Accordingly, an electronic ballast arises. This ballast can save more than 20% of electricity as compared to the conventional ballast and as the electronic ballast is ignited at a high frequency, the outputted optical wave is very stable and there is almost no flash. In addition, when a voltage of power source changes or the lamp tube is at a low temperature, the lamp tube does not flash easily, which is not only helpful to protect an eyesight but also to be able to extend a service life of the lamp tube.

Nevertheless, the aforementioned electronic ballast can be only fitted with an ordinary fluorescent tube and cannot be used on an LED daylight tube which is more economic friendly and can save electricity.

Therefore, how to solve the aforementioned issues and shortcomings of the prior art is a direction of research and development for improvement by the present inventor and related vendors.

### SUMMARY OF THE INVENTION

The primary object of the present invention is to provide an LED drive circuit device, wherein the LEDs are installed in a lamp-set and two ends of the lamp-set are provided respectively with two pins to receive a high frequency AC (Alternating Current) outputted from ballasts, with the two pins being electrically connected with a drive circuit module. The drive circuit module includes primarily a resonant network correction circuit and a rectifying circuit, wherein using the resonant network correction circuit, the high frequency AC received from the two pins can be adjusted to comply with an application range of LED current, and then using the rectifying circuit, the AC is converted into a DC (Direct Current) which is further outputted through other two pins. By applying the aforementioned circuits, the LED lamp-set can be used in an ordinary electronic ballast to achieve high compatibility.

Another object of the present invention is to provide an LED drive circuit device which can be directly installed on an existing lamp-set with an electronic ballast to ignite directly, without a need to change wiring or structures of the lamp-set.

Still another object of the present invention is to provide an LED drive circuit device, wherein as LEDs are used as a luminous source, a service life of the luminous source can be increased significantly.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a preferred embodiment of the present invention.

FIG. 2 shows a block diagram of the preferred embodiment of the present invention.

FIG. 3 shows a schematic view of a usage state of the present invention which is applied to an electronic ballast.

### DETAILED DESCRIPTION OF THE PREFERRED EMBODIMENTS

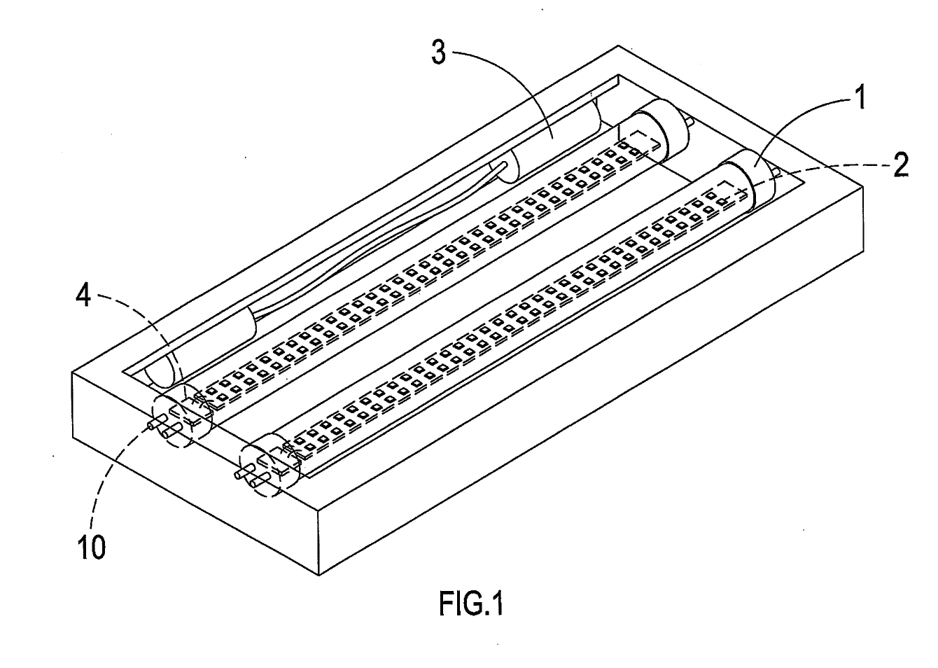

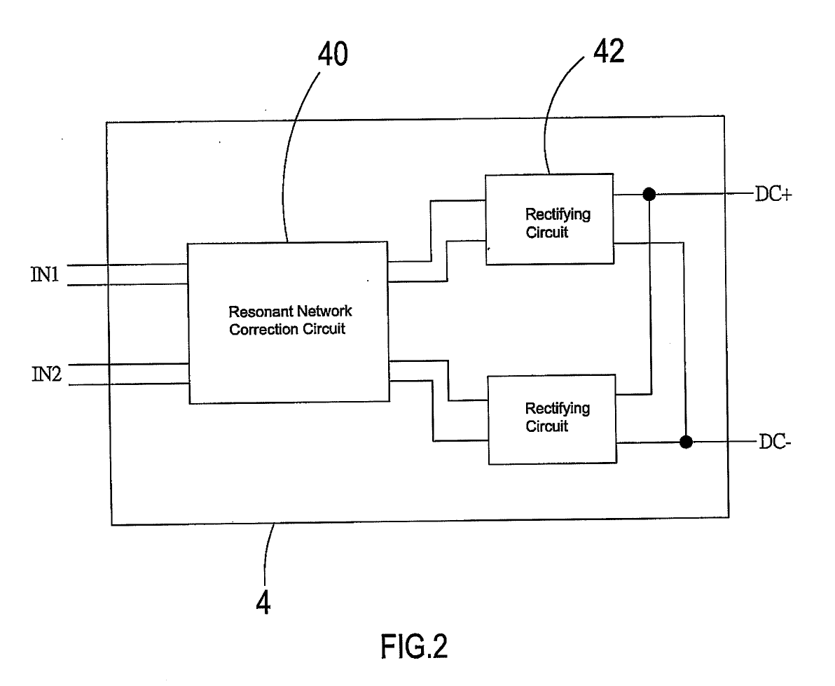

Referring to FIG. 1 and FIG. 2, it shows a three-dimensional schematic view and a block diagram, of a preferred embodiment of the present invention. As shown in the drawings, the present invention is an LED drive circuit device, wherein LEDs 2 are installed in a lamp-set 1 and two ends of the lamp-set 1 are provided respectively with two pins 10 to receive a high frequency AC outputted from a ballast 3, with the two pins 10 being further electrically connected with a drive circuit module 4. The drive circuit module 4 is primarily composed of a resonant network correction circuit 40 and a rectifying circuit 42, wherein the resonant network correction circuit 40 can adjust the high frequency AC received from the two pins 10 to comply with an application range of LED current and then the rectifying circuit 42 will convert the AC into a DC which is next outputted through other two pins 10.

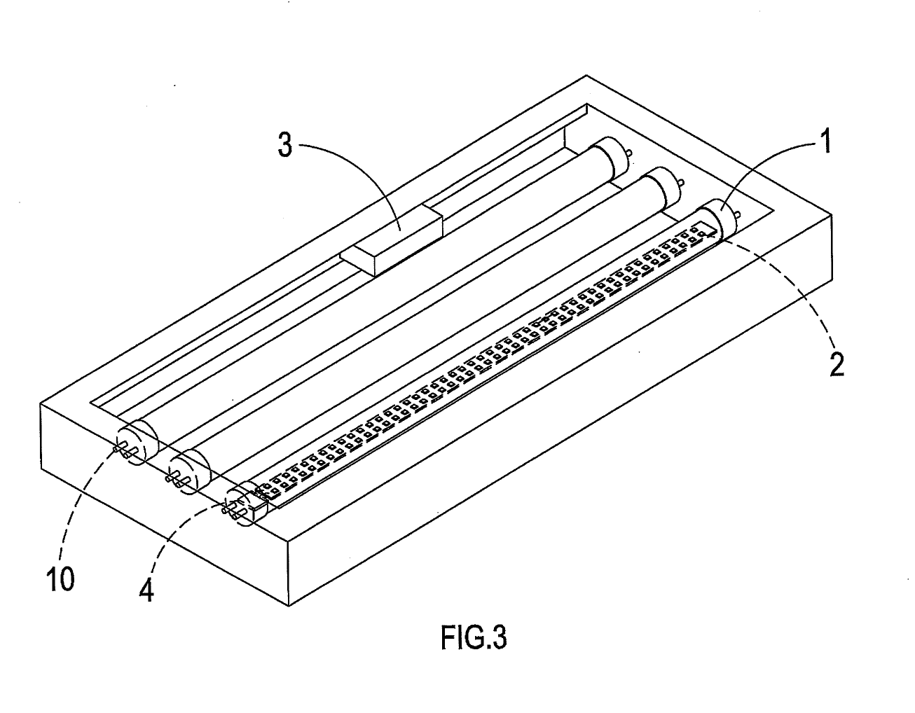

Referring to FIG. 3, it shows a schematic view of a usage state of the present invention which is applied to an electronic ballast. As shown in the drawing, an interior of a lamp tube 1 is installed with the plural LEDs 2 which are electrically connected with the drive circuit module 4. When the lamp tube 1 which is installed with the drive circuit module 4 is assembled in a lamp socket having an electronic ballast 3, the high frequency AC received by two pins 10 can be adjusted using the resonant network correction circuit 40 to comply with the application range of LED current. Next, the rectifying circuit will convert the AC into a DC by which is then outputted through other two pins 10.

By applying the aforementioned circuits, the LED lamp-set can be applied to the ordinary electronic ballast 3, achieving high compatibility. In addition, as the lamp tube 1 which is installed with the plural LEDs 2 can be directly installed on an existing lamp-set having an electronic ballast to ignite directly, there is no need to change wiring or structures of the lamp-set additionally.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An LED drive circuit device, with LEDs (Light Emitting Diode) being installed in a lamp-set, two ends of the lamp-set being provided respectively with two pins to receive a high frequency AC (Alternating Current) outputted from ballasts and the two pins being further electrically connected with a drive circuit module, wherein the drive circuit module includes a resonant network correction circuit, which is electrically connected with the pins and adjust the received AC to an AC complying with an application range of LED current; and at least one rectifying circuit, which is electrically connected with the resonant network correction circuit and converts the AC into a DC (Direct Current) to be outputted through other pins.

2. The LED drive circuit device according to claim 1, wherein the rectifying circuit outputs a voltage.

3. The LED drive circuit device according to claim 1, wherein the rectifying circuit is a bridge-type rectifying circuit.

4. The LED drive circuit device according to claim 1, wherein the rectifying circuit is an AC-to-DC conversion circuit.

5. The LED drive circuit device according to claim 1, wherein the ballast is electronic.
